(19) United States
(12) Patent Application Publication
(10) Pub. No.: US 2013/0162435 A1
(43) Pub. Date: Jun. 27, 2013

(54) ALARM SYSTEM AND METHOD FOR FANS

(71) Applicants: Hong Fu Jin Precision Industry (ShenZhen) Co., Ltd., Shenzhen (CN); Hon Hai Precision Industry Co., Ltd., New Taipei (TW)

(72) Inventor: LEI SHI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,254

(22) Filed: Dec. 24, 2012

(30) Foreign Application Priority Data
Dec. 27, 2011 (CN) 201110444256.8

(51) Int. Cl. G08B 21/18

(52) U.S. Cl. 340/584

(57) ABSTRACT

An alarm system for a fan includes a first obtaining unit, a second obtaining unit, a storage unit, a control unit, and an alarm unit. The first obtaining unit is configured to obtain a temperature of a chip at a regular time interval. When the temperature of the chip is greater than a first predetermined value, the control unit obtains a standard speed of the fan corresponding to the temperature through the second obtaining unit, and obtains a standard speed of the fan corresponding to the temperature from the storage unit. When the number of times the speed of the fan is not in synchronization with the temperature of the CPU reaches a third predetermined value, the alarm unit sends alarm information.

### BACKGROUND

1. Technical Field

The present disclosure relates to an alarm system for a fan.

2. Description of Related Art

Fans are used to dissipate heat generated by chips, such as a central processing unit (CPU) of a computer. Currently, controllers are connected to the fans to automatically adjust the speed of the fans. For instance, an embedded controller (EC) is employed to automatically adjust the speed of a fan according to the temperature of the chip in real time. However, the speed of the fan may be inaccurate if the EC is not working or malfunctioning. As a result, the temperature of the CPU may be high because the heat cannot be dissipated efficiently. The computer may shutdown without any alarm information in response to the CPU operating under high temperature.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an alarm system for a fan of the present disclosure.

FIG. 2 is a flowchart of an embodiment of an alarm method for a fan of the present disclosure.

### DETAILED DESCRIPTION

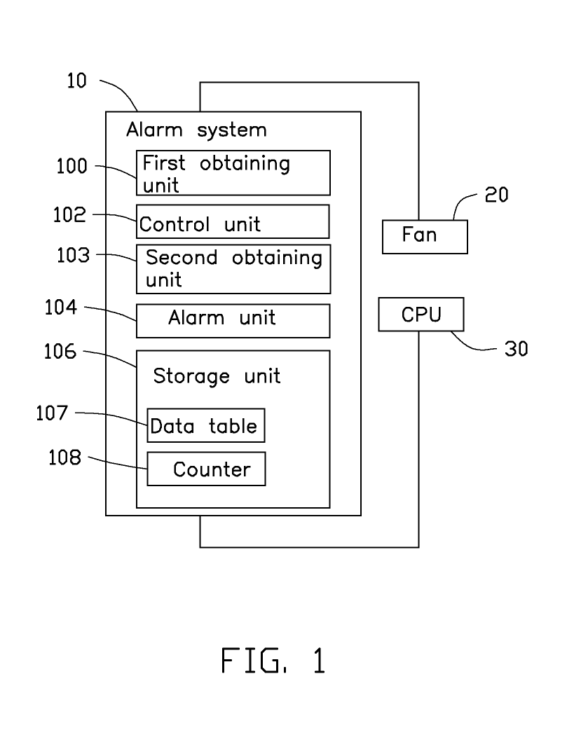

FIG. 1 illustrates an embodiment of an alarm system 10 for a fan 20 of the present disclosure. In the embodiment, the fan 20 dissipates heat generated by a central processing unit (CPU) 30. The alarm system 10 includes a first obtaining unit 100, a control unit 102, a second obtaining unit 103, an alarm unit 104, and a storage unit 106.

The first obtaining unit 100 is used to obtain a temperature of the CPU 30 at a regular time interval. The second obtaining unit 103 is used to obtain an actual speed of the fan 20. In the embodiment, a temperature range is defined for the CPU 30 to operate properly, which has a lower value and an upper value. The upper value is a first predetermined value.

The storage unit 106 stores a data table 107 and a counter 108. The data table 107 stores standard speeds of the fan 20 corresponding to different temperatures of the CPU 30. For example, the standard speed of the fan 20 is 2500 revolutions per second (r/s) in response to the temperature of the CPU 30 being 50 degree. The counter 108 stores the total number of times the speed of the fan 20 is not in synchronization with the temperature of the CPU 30, this situation is considered as being abnormal. The default value of the counter 108 is zero.

The control unit 102 is configured to determine whether the actual temperature of the CPU 30 is within the temperature range. If the actual temperature of the CPU 30 is greater than the first predetermined value, the CPU 30 operates in an unsuitable environment. Conversely, the CPU 30 operates in a suitable environment in response to the actual temperature being less than the first predetermined value.

The control unit 102 obtains the actual speed of the fan 20 by the second obtaining unit 103 in response to the temperature of the CPU 30 being greater than the first predetermined value, and obtains the standard speed corresponding to the temperature from the data table 107. Thereafter, a determination is made whether a difference value between the actual speed and the standard speed of the fan 20 is greater than a second predetermined value. If the difference value exceeds the second predetermined value, it indicates the fan 20 may be abnormal. The counter 107 is increased by 1.

If the difference value is less than the second predetermined value, it indicates that the fan 20 is normal, and the counter 108 is reset to the default value.

A determination is made by the control unit 102 whether the counter 108 reaches a third predetermined value. The control unit 102 transmits an alarm signal to the alarm unit 104 to make the alarm unit 104 send out alarm information, in response to the counter 108 reaching the third predetermined value. In the embodiment, the alarm unit 104 may send an interruption signal to an operation system, and the operation system may display the alarm information, such as “The fan of the CPU is broken, please replace it immediately.”

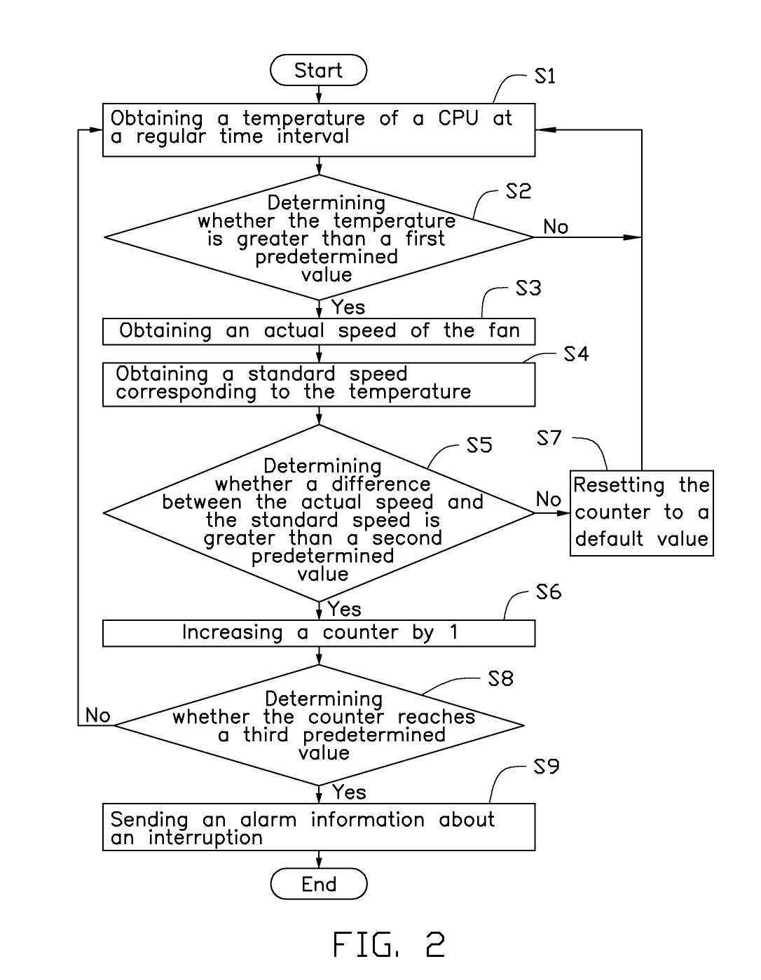

FIG. 2 illustrates an embodiment of an alarm method for a fan of the present disclosure. The alarm method includes the steps as follow.

In step S1, obtaining a temperature of the CPU 30 at a regular time interval through the first obtaining unit 100.

In step S2, determining whether the temperature of the CPU 30 is greater than a first predetermined value. If the temperature of the CPU 30 is greater than the first predetermined value, step S3 is implemented, otherwise, the process returns to step S1.

In step S3, obtaining an actual speed of the fan 20 through the second obtaining unit 103.

In step S4, obtaining a standard speed of the fan 20 according to the temperature from the data table 107.

In step S5, determining whether a difference value between the actual speed and the standard speed of the fan 20 exceeds a second predetermined value. If the difference value exceeds the second predetermined value, step S6 is implemented, otherwise, step S7 is implemented.

In step S6, increasing the counter 108 by 1, and step S8 is implemented.

In step S7, resetting the counter 108 to a default value, and returning to step S1.

In step S8, determining whether the counter 108 reaches a third predetermining value. If the counter 108 reaches the third predetermining value, step S9 is implemented, otherwise, return to step S1.

In step S9, sending alarm information about an interruption, and displaying the alarm information.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An alarm system for a fan, comprising:
a first obtaining unit configured to obtain a temperature of a chip at a regular time interval;
a second obtaining unit configured to obtain an actual speed of the fan in response to the temperature of the chip being greater than a first predetermined value;
a storage unit including a data table and a counter, wherein the data table stores standard speeds of the fan corresponding to different temperatures, the counter has a default value;
a control unit used to obtain a standard speed of the fan corresponding to the temperature from the data table in response to the temperature of the fan being greater than the first predetermined value, wherein the counter is increased by 1 in response to a difference between the actual speed and the standard speed being greater than a second predetermined value, the counter is reset to the default value in response to the difference between the actual speed and the standard speed being less than the second predetermined value; and
an alarm unit sending alarm information in response to the counter reaching a third predetermined value.

2. The alarm system of claim 1, wherein the default value is zero.

3. An alarm method for a fan, the alarm method comprising:
obtaining a temperature of a chip;
determining whether the temperature of the chip is greater than a first predetermined value;
obtaining an actual speed of the fan in response to the temperature of the chip being greater than the first predetermined value;
obtaining a standard speed of the fan corresponding to the temperature;
determining whether a difference between the actual speed and the standard speed is greater than a second predetermined value;
increasing a counter by 1 in response to the difference being greater than the second predetermined value;
resetting the counter to a default value in response to the difference being less than the second predetermined value;
determining whether the counter reaches a third predetermined value;
returning to the step of obtaining a temperature of the chip in response to the counter being less than the third predetermined value; and
sending alarm information in response to the counter being greater than the third predetermined value.

4. The alarm method of claim 3, further comprising:
returning to the step of obtaining a temperature of the chip in response to the temperature being less than the first predetermined value.

5. The alarm method of claim 3, wherein the default value of the counter is zero.
